(19) United States
(12) Patent Application Publication
(10) Pub. No.: US 2026/0245240 A1
(43) Pub. Date: Aug. 20, 2026

(54) VISUAL FEATURE SHARING FOR PARAMETER DETERMINATION

(71) Applicant: QUALCOMM Incorporated, San Diego, CA (US)

(72) Inventors: Anantharaman BALASUBRAMANIAN, San Diego, CA (US); Stelios STEFANATOS, San Diego, CA (US); Kapil GULATI, Belle Mead, NJ (US)

(21) Appl. No.: 19/472,058

(22) PCT Filed: Apr. 9, 2024
(86) PCT No.: PCT/US2024/023751

§ 371 Date: Oct. 2, 2025

(30) Foreign Application Priority Data
Jun. 6, 2023 (GR) 20230100447

(51) Int. Cl. G06T 7/73; G06V 10/46

(52) U.S. Cl. CPC G06T 7/73; G06V 10/462

(57) ABSTRACT

Systems and techniques are described herein for determining parameters of a tracking object. For instance, a method for determining parameters of a tracking object is provided. The method may include determining a plurality of keypoints in an image captured using a camera of the tracking object; generating a plurality of descriptors based on the image, the plurality of descriptors comprising a respective descriptor of each keypoint of the plurality of keypoints; transmitting, to a target object, information associated with the plurality of descriptors; receiving, from the target object, a plurality of locations, the plurality of locations comprising a respective location of each keypoint of at least a subset of the plurality of keypoints in a world coordinate system; and determining, based on the plurality of locations and the image, at least one of a pose of the camera or intrinsic parameters of the camera.

### TECHNICAL FIELD

The present disclosure generally relates to determining parameters associated with poses of objects. For example, aspects of the present disclosure include systems and techniques for sharing visual features for determining parameters, such as image sensor (e.g., camera) extrinsic parameters and/or intrinsic parameters.

### BACKGROUND

Visual odometry may be used in various applications, such as automotive applications. Visual odometry generally involves comparing consecutive image frames captured from a single camera (e.g., in a video sequence) to infer the trajectory and pose of an object, such as a vehicle. The pose refers to the translation of the vehicle (e.g., geometrical movement of the vehicle in two or three dimensions) and orientation/rotation of the vehicle (e.g., pitch, yaw, roll). Visual odometry may be used, for example in Advanced Driver-Assistance Systems (ADAS) applications, to determine the vehicle pose for collision avoidance, cooperative driving, and/or other vehicular safety features. Examples of fields where visual odometry may be used include autonomous driving by autonomous driving systems (e.g., of autonomous vehicles), autonomous navigation by a robotic system (e.g., an automated vacuum cleaner, an automated surgical device, etc.), aviation systems, among others.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for sharing visual features for determining parameters. According to at least one example, a method is provided for determining parameters of a tracking object. The method includes: determining a plurality of keypoints in an image captured using a camera of the tracking object; generating a plurality of descriptors based on the image, the plurality of descriptors comprising a respective descriptor of each keypoint of the plurality of keypoints; transmitting, to a target object, information associated with the plurality of descriptors; receiving, from the target object, a plurality of locations, the plurality of locations comprising a respective location of each keypoint of at least a subset of the plurality of keypoints in a world coordinate system; and determining, based on the plurality of locations and the image, at least one of a pose of the camera or intrinsic parameters of the camera.

In another example, an apparatus for determining parameters of a tracking object is provided that includes at least one memory and at least one processor (e.g., configured in circuitry) coupled to the at least one memory. The at least one processor is configured to: determine a plurality of keypoints in an image captured using a camera of the tracking object; generate a plurality of descriptors based on the image, the plurality of descriptors comprising a respective descriptor of each keypoint of the plurality of keypoints; cause at least one transmitter to transmit, to a target object, information associated with the plurality of descriptors; receive, from the target object, a plurality of locations, the plurality of locations comprising a respective location of each keypoint of at least a subset of the plurality of keypoints in a world coordinate system; and determine, based on the plurality of locations and the image, at least one of a pose of the camera or intrinsic parameters of the camera. In some cases, the apparatus includes the at least one transmitter configured to transmit the information associated with the plurality of descriptors.

In another example, a non-transitory computer-readable medium is provided that has stored thereon instructions that, when executed by one or more processors, cause the one or more processors to: determine a plurality of keypoints in an image captured using a camera of a tracking object; generate a plurality of descriptors based on the image, the plurality of descriptors comprising a respective descriptor of each keypoint of the plurality of keypoints; cause at least one transmitter to transmit, to a target object, information associated with the plurality of descriptors; receive, from the target object, a plurality of locations, the plurality of locations comprising a respective location of each keypoint of at least a subset of the plurality of keypoints in a world coordinate system; and determine, based on the plurality of locations and the image, at least one of a pose of the camera or intrinsic parameters of the camera.

In another example, an apparatus for determining parameters of a tracking object is provided. The apparatus includes: means for determining a plurality of keypoints in an image captured using a camera of the tracking object; means for generating a plurality of descriptors based on the image, the plurality of descriptors comprising a respective descriptor of each keypoint of the plurality of keypoints; means for transmitting, to a target object, information associated with the plurality of descriptors; means for receiving, from the target object, a plurality of locations, the plurality of locations comprising a respective location of each keypoint of at least a subset of the plurality of keypoints in a world coordinate system; and means for determining, based on the plurality of locations and the image, at least one of a pose of the camera or intrinsic parameters of the camera.

According to another example, a method is provided for determining locations at a target object. The method includes: receiving, from a tracking object, a plurality of descriptors comprising a respective descriptor for each keypoint of a plurality of keypoints; obtaining a plurality of images captured by a camera of the target object; obtaining a plurality of camera locations comprising a respective camera location corresponding to each image of the plurality of images; identifying at least a subset of the plurality of keypoints in each image of at least a subset of the plurality of images based on the plurality of descriptors; and determining a plurality of locations comprising a respective location of each keypoint of at least the subset of the plurality of keypoints in a world coordinate system based on the plurality of images and the plurality of camera locations.

In another example, an apparatus for determining locations at a target object is provided that includes at least one memory and at least one processor (e.g., configured in circuitry) coupled to the at least one memory. The at least one processor configured to: receive, from a tracking object, a plurality of descriptors comprising a respective descriptor for each keypoint of a plurality of keypoints; obtain a plurality of images captured by a camera of the target object; obtain a plurality of camera locations comprising a respective camera location corresponding to each image of the plurality of images; identify at least a subset of the plurality of keypoints in each image of at least a subset of the plurality of images based on the plurality of descriptors; and determine a plurality of locations comprising a respective location of each keypoint of at least the subset of the plurality of keypoints in a world coordinate system based on the plurality of images and the plurality of camera locations.

In another example, a non-transitory computer-readable medium is provided that has stored thereon instructions that, when executed by one or more processors, cause the one or more processors to: receive, from a tracking object, a plurality of descriptors comprising a respective descriptor for each keypoint of a plurality of keypoints; obtain a plurality of images captured by a camera of a target object; obtain a plurality of camera locations comprising a respective camera location corresponding to each image of the plurality of images; identify at least a subset of the plurality of keypoints in each image of at least a subset of the plurality of images based on the plurality of descriptors; and determine a plurality of locations comprising a respective location of each keypoint of at least the subset of the plurality of keypoints in a world coordinate system based on the plurality of images and the plurality of camera locations.

In another example, an apparatus for determining locations at a target object is provided. The apparatus includes: means for receiving, from a tracking object, a plurality of descriptors comprising a respective descriptor for each keypoint of a plurality of keypoints; means for obtaining a plurality of images captured by a camera of the target object; means for obtaining a plurality of camera locations comprising a respective camera location corresponding to each image of the plurality of images; means for identifying at least a subset of the plurality of keypoints in each image of at least a subset of the plurality of images based on the plurality of descriptors; and means for determining a plurality of locations comprising a respective location of each keypoint of at least the subset of the plurality of keypoints in a world coordinate system based on the plurality of images and the plurality of camera locations.

In some aspects, one or more of the apparatuses described herein is, can be part of, or can include a vehicle (or a computing device or system of a vehicle), a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 illustrates an example of a wireless communication network configured to support sidelink communication which may be used according to various aspects of the present disclosure;

FIG. 2 is a diagram illustrating an example of an image including a keypoint, according to various aspects of the present disclosure;

FIG. 3 is a diagram illustrating an example of a relative pose between a tracking vehicle and a target vehicle according to various aspects of the present disclosure;

FIG. 4 is a diagram illustrating example process including signaling between tracking object and target object for parameter determination according to various aspects of the present disclosure;

FIG. 5 is a diagram illustrating another example process including signaling between tracking object and target object for parameter determination according to various aspects of the present disclosure;

FIG. 6 is a diagram illustrating an example of relative pose determination using keypoints from images captured at different cameras and according to various aspects of the present disclosure;

FIG. 7 is a flow diagram illustrating an example process for determining parameters of a tracking object, in accordance with aspects of the present disclosure;

FIG. 8 is a flow diagram illustrating another example process for determining parameters of a tracking object, in accordance with aspects of the present disclosure;

FIG. 9 illustrates an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Mobile devices equipped with a camera may be capable of determining the two-dimensional or three-dimensional displacement of the camera over time. For example, in automotive applications, visual odometry may be used to estimate the trajectory and pose of the vehicle. For some applications, such as Advanced Driver-Assistance Systems (ADAS), high accuracy in relative vehicle pose determination (e.g., relative to another vehicle or object) may improve reaction time to lane changes, collision avoidance, and/or cooperative driving. Without highly accurate relative pose determination, ADAS systems may bias that vehicles are going straight in their lanes, which increases the reaction time of the ADAS system to react to a lane change. The high accuracy requirements of ADAS systems may not be met using only the on-board camera to determine the relative vehicle pose due to the delay between image captures and field of view restrictions.

To decrease the time to obtain a relative vehicle pose and to improve the accuracy of relative vehicle pose calculations, some techniques include sharing of visual features between two or more wireless communication devices to enable determination of the relative pose between the wireless communication devices. For example, a first wireless communication device (which may be referred to as a “tracking object” or “tracking wireless communication device”) may track a second wireless communication device (which may be referred to as a “target object” or “target wireless communication device”). By tracking the target wireless communication device, the tracking wireless communication device may determine its relative position. To track the target wireless communication device, the tracking wireless communication device may transmit a request for visual feature sharing to the target wireless communication device and in response receive a message from the target wireless communication device including a plurality of features (e.g., first features) within a field of view (e.g., a first field of view) associated with the target wireless communication device. Each first feature may include a respective first keypoint of a first image captured by the target wireless communication device. The tracking wireless communication device may then obtain a plurality of second features in a second field of view associated with the tracking wireless communication device. Each second feature may also include a respective second keypoint of a second image captured by the tracking wireless communication device. The tracking wireless communication device may calculate a relative pose of the tracking wireless communication device with respect to the target wireless communication device based on an association between the plurality of first features and the plurality of second features.

Such techniques may include the target wireless communication device sharing its intrinsic parameters (e.g., camera focal length, camera image size, camera distortion parameters) with the tracking wireless communication device such that the tracking wireless communication device is enabled to calculate its relative pose. However, in many situations, intrinsic parameter of wireless communication devices (e.g., vehicles) may change over time (or may be known only approximately), and hence may need to be re-computed. In some cases, intrinsic parameters may be unknown to the wireless communication devices. Additionally, or alternatively, in some cases, wireless communication devices simply may not want to share intrinsic parameters with other wireless communication devices.

Systems, apparatuses, processes (also referred to as methods), and computer-readable media (collectively referred to as “systems and techniques”) are described herein for sharing visual features for parameter determination. For example, a tracking object may capture an image using a camera of the tracking object. The tracking object may determine keypoints in the image. The keypoints may be visually distinct. The tracking object may generate a respective descriptor descriptive of each keypoint. The tracking object may transmit the descriptors to a target object.

The target object may receive the descriptors from the tracking object. The target object may capture images using a camera of the target object. Also, the target object may obtain a respective camera location corresponding to each of the images. For example, the target object may obtain camera-location information (e.g., latitude and longitude coordinates) (e.g., in a world coordinate system) indicative of a location from which each of the images was captured. The target object may identify at least a subset of the keypoints in at least a subset of the images based on the plurality of descriptors. For example, based on the descriptors, the target object may seek to identify the keypoints in each of the images captured by the camera of the target object. Some of the images captured by the camera of the target object may include some of the keypoints. The target object may determine a respective location of each keypoint of the subset of keypoints in a world coordinate system based on the images and the camera locations. For example, for each of the keypoints that were identified in images captured by the camera of the target object, the target object may determine a position of the keypoint based on the images and based on the camera locations corresponding to the images. The target object may transmit the locations of the keypoints to the tracking object.

The tracking object may receive the plurality of locations of the keypoints from the target object. The tracking object may determine, based on the locations of the keypoints and the image, at least one of a pose of the camera of the tracking object or intrinsic parameters of the camera of the tracking object. For example, based on the locations of the keypoints in the world coordinate system, and based on the image including the keypoints captured by the camera of the tracking object, the tracking object may determine a pose of the camera of the tracking object and/or intrinsic parameters of the camera of the tracking object.

The systems and techniques may allow a tracking object to determine parameters of the tracking object by sharing visual features. The parameters may include extrinsic parameters including a pose of the vehicle (e.g., the position of the vehicle in two or three dimensions in a reference or global coordinate system and an orientation/rotation of the vehicle (e.g., pitch, yaw, roll)). The parameters may also include intrinsic parameters including, as examples, camera focal length, camera image size, and/or camera distortion parameters. Further, the systems and techniques may allow the tracking object to determine the parameters without the need for the target object to share intrinsic parameters with the tracking object. By not requiring the sharing of intrinsic parameters, the systems and techniques may improve on other feature-sharing techniques by enabling determining of parameters based on shared features in a wider variety of circumstances. For example, systems and techniques enable determining of parameters based on shared features in instances when the target object does not know its intrinsic parameters (e.g., based on a recent change) and/or instances when the target object does not want to share its intrinsic parameters.

As one example, a vehicle may exit a parking garage and may not have an accurate location. The vehicle may engage in the techniques described herein as a tracking object and may thereby determine its location without the need for a target object (e.g., another vehicle or a roadside unit (RSU)) to share its intrinsic parameters. As another example, a camera of a vehicle may be newly installed or adjusted. The vehicle may not know the intrinsic parameters of the camera. The vehicle may engage in the techniques described herein as a tracking object and may thereby determine the intrinsic parameters of the camera without the need for a target object to share its intrinsic parameters. As another example, an RSU (e.g., a traffic camera) may periodically update its intrinsic parameters by engaging the techniques described herein as a tracking object without the need for a target object to share its intrinsic parameters.

Various aspects of the application will be described with respect to the figures below.

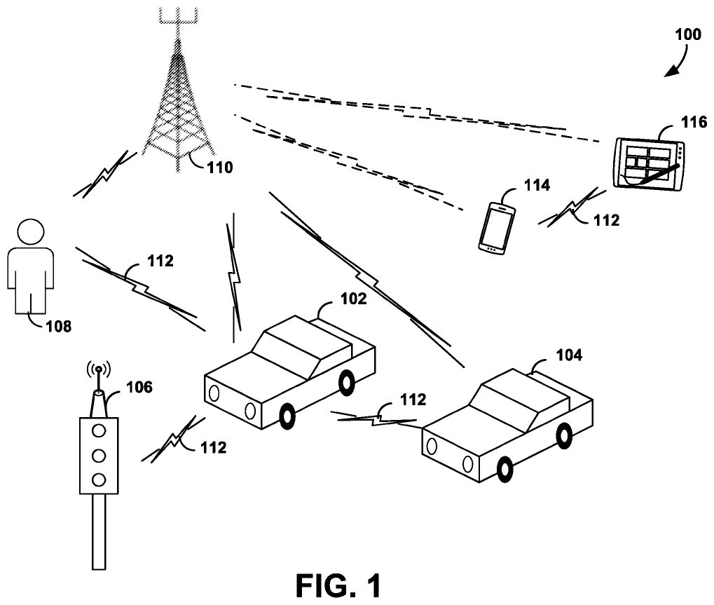

FIG. 1 illustrates an example of a wireless communication network 100 configured to support sidelink communication which may be used according to various aspects of the present disclosure. Wireless communication networks (e. g, wireless communication network 100) are deployed to provide various communication services such as voice, video, packet data, messaging, broadcast, and the like. Wireless communication network 100 may support both access links and sidelinks for communication between wireless devices. An access link may refer to any communication link between a client device (e.g., a user equipment (UE), a station (STA), or other client device) and a base station (e.g., a 3GPP gNB, a 3GPP eNB, a Wi-Fi access point (AP), or other base station). For example, an access link may support uplink signaling, downlink signaling, connection procedures, etc.

A sidelink may refer to any communication link between client devices (e.g., UEs, STAs, etc.). For example, a sidelink may support device-to-device (D2D) communications, vehicle-to-everything (V2X) and/or vehicle-to-vehicle (V2V) communications, message relaying, discovery signaling, beacon signaling, or any combination of these or other signals transmitted over-the-air from one UE to one or more other UEs. In some examples, sidelink communications may be transmitted using a licensed frequency spectrum or an unlicensed frequency spectrum (e.g., 5 GHz or 6 GHZ). As used herein, the term sidelink may refer to 3GPP sidelink (e.g., using a PC5 sidelink interface), Wi-Fi direct communications (e.g., according to a Dedicated Short-Range Communication (DSRC) protocol), or using any other direct device-to-device communication protocol.

V2X communications may include communications between vehicles (e.g., vehicle-to-vehicle (V2V)), communications between vehicles and infrastructure (e.g., vehicle-to-infrastructure (V2I)), communications between vehicles and pedestrians (e.g., vehicle-to-pedestrian (V2P)), and/or communications between vehicles and network severs (vehicle-to-network (V2N)). For V2V, V2P, and V2I communications, data packets may be sent directly (e.g., using a PC5 interface, using an 802.11 DSRC interface, etc.) between vehicles without going through the network, eNB, or gNB. V2X-enabled vehicles, for instance, may use a short-range direct-communication mode that provides 160° non-line-of-sight (NLOS) awareness, complementing onboard line-of-sight (LOS) sensors, such as cameras, radio detection and ranging (RADAR), Light Detection and Ranging (LIDAR), among other sensors. The combination of wireless technology and onboard sensors enables V2X vehicles to visually observe, hear, and/or anticipate potential driving hazards (e.g., at blind intersections, in poor weather conditions, and/or in other scenarios). V2X vehicles may also understand alerts or notifications from other V2X-enabled vehicles (based on V2V communications), from infrastructure systems (based on V2I communications), and from user devices (based on V2P communications). Infrastructure systems may include roads, stop lights, road signs, bridges, toll booths, and/or other infrastructure systems that may communicate with vehicles using V2I messaging.

Depending on the desired implementation, sidelink communications may be performed according to 3GPP communication protocols sidelink (e.g., using a PC5 sidelink interface according to LTE, 5G, etc.), Wi-Fi direct communication protocols (e.g., DSRC protocol), or using any other device-to-device communication protocol. In some examples, sidelink communication may be performed using one or more Unlicensed National Information Infrastructure (U-NII) bands. For instance, sidelink communications may be performed in bands corresponding to the U-NII-4 band (5.850-5.925 GHz), the U-NII-5 band (5.925-6.425 GHz), the U-NII-6 band (6.425-6.225 GHz), the U-NII-7 band (6.225-6.875 GHz), the U-NII-8 band (6.875-7.125 GHz), or any other frequency band that may be suitable for performing sidelink communications.

In some examples, sidelink communication may include D2D or V2X communication. V2X communication involves the wireless exchange of information directly between not only vehicles (e.g., vehicles 102 and 104) themselves, but also directly between vehicles 102/104 and infrastructure (e.g., roadside units 106), such as streetlights, buildings, traffic cameras, tollbooths or other stationary objects, vehicles 102/104 and pedestrians 108, and vehicles 102/104 and wireless communication networks (e.g., base station 110). In some examples, V2X communication may be implemented in accordance with the New Radio (NR) cellular V2X standard defined by 3GPP, Release 16, or other suitable standard.

V2X communication enables vehicles 102 and 104 to obtain information related to the weather, nearby accidents, road conditions, activities of nearby vehicles and pedestrians, objects nearby the vehicle, and other pertinent information that may be utilized to improve the vehicle driving experience and increase vehicle safety. For example, such V2X data may enable autonomous driving and improve road safety and traffic efficiency. For example, the exchanged V2X data may be utilized by a V2X connected vehicle 102 and 104 to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device of a pedestrian/cyclist 108 may be utilized to trigger a warning sound, vibration, flashing light, etc., in case of imminent danger.

The sidelink communication between vehicle-UEs (V-UEs) 102 and 104 or between a V-UE 102 or 104 and either an RSU 106 or a pedestrian-UE (P-UE) 108 may occur over a sidelink 112 utilizing a proximity service (ProSe) PC5 interface. In various aspects of the disclosure, the PC5 interface may further be utilized to support D2D sidelink 112 communication in other proximity use cases (e.g., other than V2X). Examples of other proximity use cases may include smart wearables, public safety, or commercial (e.g., entertainment, education, office, medical, and/or interactive) based proximity services. In the example shown in FIG. 1, ProSe communication may further occur between UEs 114 and 116.

Visual features and/or location information may be shared via sidelink communications (e.g., V2X) to determine parameters of a camera of a wireless communication device (e.g., a V2X device, such as a vehicle). For example, two or more vehicles and/or roadside units (e.g., traffic cameras) may share visual features (and/or image from which the visual features were derived) and/or location information associated with the visual features. One of the vehicles and/or roadside units may determine extrinsic and/or intrinsic parameters of its camera based on the shared visual features.

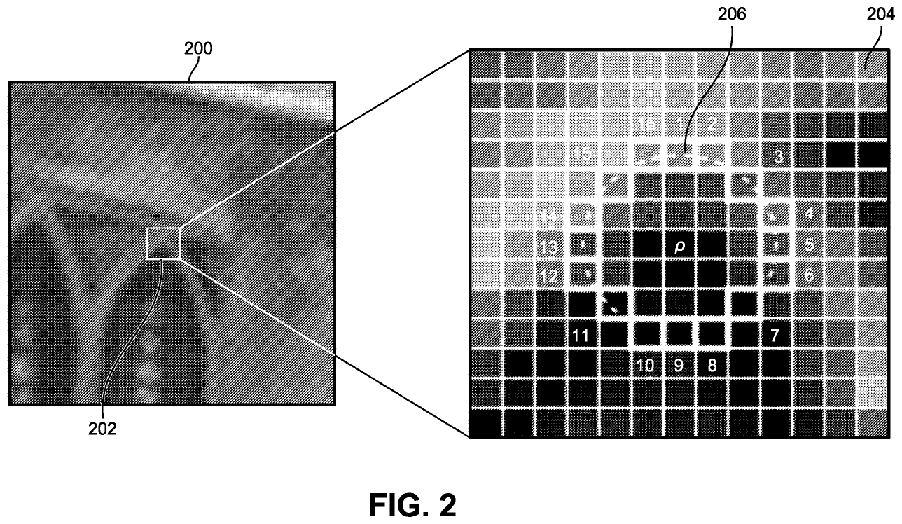

FIG. 2 is a diagram illustrating an example of an image 200 including a keypoint 202 according to various aspects of the present disclosure. As used herein, the term keypoint 202 refers to a group of pixels 204 in the image 200 that can be tracked from image frame to image frame, such as a corner point on an object. One example of a corner detection method shown in FIG. 2 is the features from accelerated segment test (FAST) (Machine Learning for High-Speed Corner Detection, Edward Rosten & Tom Drummond, ECCV 2006: Computer Vision—ECCV 2006 pp 430-443, Part of the Lecture Notes in Computer Science book series (LNIP, volume 3951)). In the FAST method, a pixel 204 under test p with intensity Ip may be identified as an interest point. A circle of sixteen pixels (pixels 1-16) around the pixel under test (e.g., a Bresenham circle of radius 3) may then be identified. The pixel p may be considered a corner point if there exists a set of n contiguous pixels in the circle of sixteen pixels that are all brighter than Ip+t, or all darker than Ip−t, where t is a threshold value and n is configurable. In this example, n may be twelve. For example, the intensity of pixels 1, 5, 9, and 13 of the circle may be compared with Ip. If at least three of the four pixels do not satisfy the threshold criteria, the pixel p is not considered an interest point. As evident from FIG. 2, at least three of the four pixels satisfy the threshold criteria. Therefore, all sixteen pixels may be compared to pixel p to determine if twelve contiguous pixels meet the threshold criteria. This process may be repeated for each pixel 204 in the image 200 to identify the corner points corresponding to keypoints 202 in the image 200.

Although FIG. 2 illustrates a FAST keypoint identifying method, it should be understood that the present disclosure is applicable to any keypoint identifying method. Examples of keypoint identifying methods may include, but are not limited to, SURF (speeded-up robust features), SIFT (scale-invariant feature transform), ORB (oriented FAST (features from accelerated segment test) and rotated BRIEF (binary robust independent elementary feature)), BRIEF, and Harris corner point.

As indicated above, a keypoint 202 represents a feature of an image 200 that may be tracked. For example, various cross-correlation or optical flow methods may track features (keypoints) across image frames. In some examples, each feature may further include a feature descriptor that assists with the tracking process. A feature descriptor may summarize, in vector format (e.g., of constant length) one or more characteristics of the keypoint 202. For example, the feature descriptor may correspond to the intensity of the keypoint 202. In general, feature descriptors are independent of the positions of keypoint 202, robust against image transformations, and scale independently. Thus, keypoints with feature descriptors may be independently redetected in each image frame and then subjected to a keypoint matching/tracking procedure. For example, the keypoints in two different images with matching descriptors and the smallest distance between them may be considered to be matching keypoints. Examples of feature-descriptor methods may include, but are not limited to, ORB, SURF, and BRIEF.

A relative pose of two cameras may be calculated based on the two-dimensional displacement of a plurality of keypoints in image from each of the cameras. For example, the pose may be determined by forming and factoring an essential matrix using eight keypoints 202 or using Nister's method with five keypoints 202. As another example, a Perspective-n-Point (PnP) algorithm with three keypoints 202 may be used to determine the pose if keypoint depth is also being tracked. In some aspects, images captured by different cameras (e.g., of different wireless communication devices) that contain a minimum number of the same features (e.g., based on the pose determination method) may be used to determine the relative pose between the cameras.

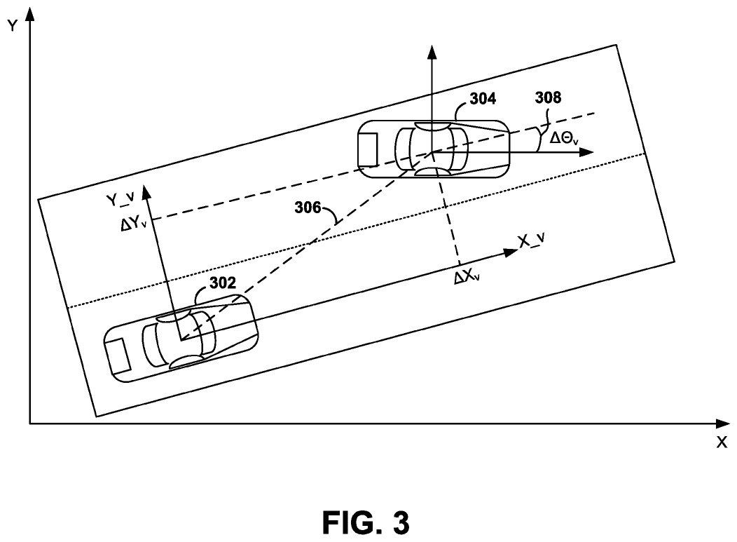

FIG. 3 is a diagram illustrating an example of a relative pose between a tracking vehicle 302 and a target vehicle 304 according to various aspects of the present disclosure. In some examples, each of tracking vehicle 302 and target vehicle 304 may be, or may include, a wireless communication device, such as a V2X device including a sensor (e.g., a camera) for capturing images. In addition, tracking vehicle 302 and target vehicle 304 may each be ego vehicles within an intelligent transportation system. Tracking vehicle 302 and target vehicle 304 are shown in a two-dimensional reference coordinate system represented by the X-axis and Y-axis.

The relative pose between tracking vehicle 302 and target vehicle 304 may be determined based on a rotated coordinate system centered at one of the vehicles (e.g., tracking vehicle 302) represented by the X_v axis and Y_v axis. In some examples, the rotated coordinate system may be centered at a camera of the tracking vehicle 302. The relative pose of target vehicle 304 with respect to tracking vehicle 302 may include a relative translation 306 of target vehicle 304 in the X_v and Y_v directions corresponding to AXv and AYv. In addition, the relative pose of target vehicle 304 with respect to tracking vehicle 302 may include a relative orientation 308 of vehicle 304 corresponding to angle ΔΘᵥ.

To facilitate relative pose determination, various aspects of the disclosure provide mechanisms for visual feature sharing between wireless communication devices (e.g., tracking vehicle 302 and target vehicle 304). For example, tracking vehicle 302 may capture an image within a field of view of an on-board camera of tracking vehicle and identify a plurality of keypoints in the image using FAST, SURF, ORB, BRIEF, SIFT, Harris corner points or another keypoint detection algorithm. Further, tracking vehicle 302 may determine a descriptor corresponding to each of the keypoints using ORB, SURF, BRIEF, or another feature-descriptor algorithm. In some cases, the number of keypoints, N to be provided may be based on an intensity metric for each keypoint specified as the sharpness of a corner as in Harris corner measure. For example, keypoints corresponding to the first N highest corners may be identified. In some cases, the identified keypoints may be uniformly sampled in the image space. Tracking vehicle 302 may transmit the descriptors to target vehicle 304.

Target vehicle 304 may receive the descriptors from tracking vehicle 302 and identify keypoints corresponding to the descriptors in images captured by target vehicle 304 of a field of view captured by an on-board camera of target vehicle 304. For example, target vehicle 304 may match keypoints detected in images captured by the camera of target vehicle 304 with keypoints described by the descriptors received from tracking vehicle 302 using a feature-matching technique. As another example, target vehicle 304 may independently redetect keypoints with descriptors (such as SIRF or ORB) in the images captured by the camera of target vehicle 304 and match or associate the redetected keypoints with the keypoints described by the descriptors received from tracking vehicle 302

After identifying the keypoints in the images captured by target vehicle 304, target vehicle 304 may determine locations of each of the keypoints. In some cases, target vehicle 304 may determine the locations of the keypoints according to a coordinate system of target vehicle 304 (e.g., similar to the coordinate system centered on target vehicle 304). In other cases, target vehicle 304 may know its location in a reference coordinate system (e.g., the XY coordinate system). In such cases, target vehicle 304 may determine the location of the keypoints according to the reference coordinate system. Target vehicle 304 may transmit the locations of the keypoints to tracking vehicle 302.

In some cases, to enable robust matching of features, tracking vehicle 302 may communicate one or more sharing parameters to target vehicle 304. The sharing parameters may be, or may include, instructions to cause tracking vehicle 302 and target vehicle 304 to speak the same ‘language’ to enable to tracking vehicle 302 to determine its location. The sharing parameters may include, a number of frames N₁ across which the keypoints are to be consistent for sharing features. For example, through the sharing parameters, tracking vehicle 302 may instruct target vehicle 304 to share keypoints (or locations of keypoints) that are consistent across a certain number of frames. This parameter leverages consistency of observing keypoints across time which enables repeatability of features and would be more robust than sharing key-points on a frame-by-frame basis. Additionally, or alternatively, the sharing parameters may include a contrast threshold (strength of detected keypoint), and/or edge threshold (e.g., corner-ness measure). Such sharing parameters may ensure that shared keypoints and descriptors are robust.

Tracking vehicle 302 may receive the locations of the keypoints (and an indication of a correspondence between the locations and the keypoints) from tracking vehicle 302. Tracking vehicle 302 may determine its location based on the locations of the keypoints and the positions of the keypoints in the image captured by the tracking object (e.g., by solving the Perspective n-Point (PnP) problem). In cases where target vehicle 304 provided the location of the keypoints in a coordinate system corresponding to target vehicle 304, tracking vehicle 302 may determine a relative pose between tracking vehicle 302 and target vehicle 304. In cases where target vehicle 304 provided the location of the keypoints in a reference system corresponding to target vehicle 304, tracking vehicle 302 may determine its location in the reference coordinate system.

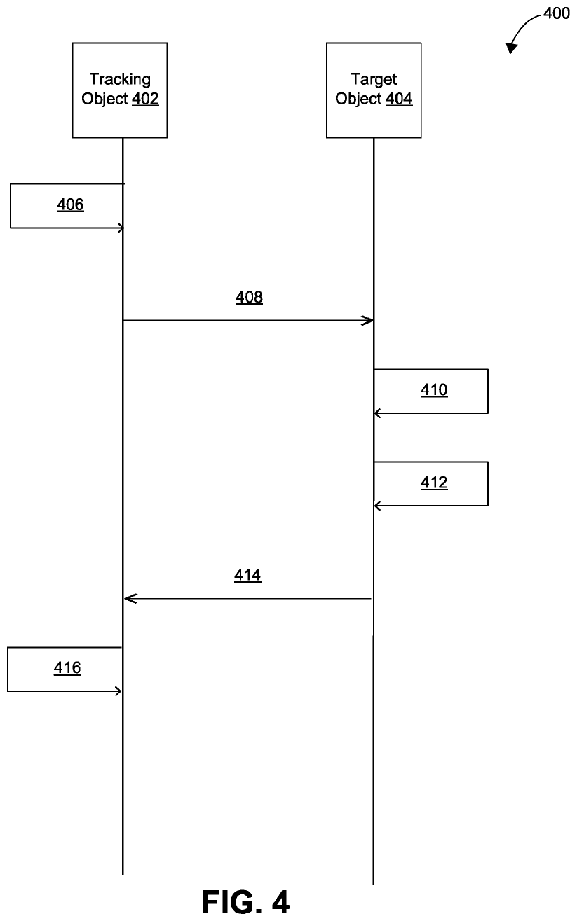

FIG. 4 is a diagram illustrating exemplary process 400 including signaling between tracking object 402 and target object 404 for parameter determination according to various aspects of the present disclosure. Each of the tracking object 402 and target object 404 may be, for example, a wireless communication device. For example, tracking object 402 and/or target object 404 may be a vehicle (e.g., an ego vehicle), a UE, a V2X device, a RSU (e.g., a traffic camera), or a sidelink device. The tracking object 402 and target object 404 may be in the vicinity of one another. In some examples, the tracking object 402 and target object 404 may have established a sidelink therebetween (e.g., via discovery signals). Further, in some examples, tracking object 402 and target object 404 may have agreed to share features and/or location information.

At operation 406, tracking object 402 may determine a plurality of keypoints in an image captured using a camera of tracking object 402. For example, tracking object 402 may capture an image within a field of view of an on-board camera of tracking vehicle and identify a plurality of keypoints in the image using FAST, ORB, BRIEF, SIFT, Harris corner points or another keypoint detection algorithm. Further at operation 406, tracking object 402 may generate a plurality of descriptors based on the image (e.g., using ORB, SURF, BRIEF, or another feature-descriptor algorithm). The plurality of descriptors may include a respective descriptor of each keypoint of the plurality of keypoints.

At operation 408, tracking object 402 may transmit information associated with the plurality of descriptors to target object 404. For example, tracking object 402 may transmit the descriptors, encoded for transmission, to target object 404. In some examples, the information may be transmitted via one or more of a unicast sidelink message, a multicast (or groupcast) sidelink message, or a broadcast sidelink message. In other examples, the information may be transmitted via a network entity (e.g., a base station or gNB in an aggregated base station architecture, or a central unit (CU), a distributed unit (DU), a radio unit (RU), a Near-Real Time (Near-RT) RAN Intelligent Controller (RIC), or a Non-Real Time (Non-RT) RIC in a disaggregated base station architecture) in wireless communication with the tracking object 402 and target object 404. For example, the information may be transmitted to the network entity via a Uu link between tracking object 402 and the network entity and the network entity may transmit the information to target object 404 via a Uu link between the network entity and target object 404.

At operation 410, target object 404 may identify at least a subset of the keypoints (determined by tracking object 402 at operation 406) in images captured by target object 404 based on the plurality of descriptors transmitted at operation 408. For example, at, or prior to operation 410, target object 404 may obtain images captured by a camera of target object 404 and camera locations indicative of a location from which each of the images was captured. Based on the descriptors, target object 404 may seek to identify the keypoints (determined by tracking object 402 at operation 406) in the images captured by target object 404, e.g., using a feature-matching technique. The keypoints that are identified in the images captured by target object 404 may be the subset of keypoints.

In some cases, at part of operation 410, target object 404 may select keypoints from among the keypoints provided by tracking object 402. For example, target object 404 may determine which keypoints provided by tracking object 402 are repeatable and consistent and may select such keypoints. In such cases, the subset of keypoints may include the selected keypoints and may exclude keypoints that are not selected. Such selection may precede, or follow, the identification of the keypoints in the images captured by target object 404. In some cases, though not illustrated in FIG. 4, tracking object 402 may transmit sharing parameters to target object 404. The sharing parameters may include instructions indicative of a threshold for repeatability and/or consistency for target object 404 to use when selecting keypoints.

At operation 412, target object 404 may determine a location of each keypoint of the subset of keypoints in a world coordinate system based on the images captured by the camera of target object 404 and the plurality of camera locations. For example, target object 404 may triangulate a respective location for each of the keypoints based on the images captured by the camera of target object 404 and based on the camera locations from which the images were captured. In some cases, target object 404 may determine the locations in a coordinate system of target object 404. In other cases, target object 404 may determine the locations in a reference coordinate system (e.g., a world coordinate system).

At operation 414, target object 404 may transmit information associated with the locations of the keypoints to tracking object 402. For example, target object 404 may transmit the locations of the keypoints, encoded for transmission, to tracking object 402. Further, target object 404 may transmit information indicative of a correspondence between the locations and the keypoints to tracking object 402. For example, target object 404 may transmit a bit mask indicative of which keypoints correlate to which location. In some examples, the information may be transmitted via one or more of a unicast sidelink message, a multicast (or groupcast) sidelink message, or a broadcast sidelink message. In other examples, the information may be transmitted via a network entity (e.g., a base station or gNB in an aggregated base station architecture, or a central unit (CU), a distributed unit (DU), a radio unit (RU), a Near-Real Time (Near-RT) RAN Intelligent Controller (RIC), or a Non-Real Time (Non-RT) RIC in a disaggregated base station architecture) in wireless communication with the tracking object 402 and target object 404. For example, the information may be transmitted to the network entity via a Uu link between target object 404 and the network entity and the network entity may transmit the information to tracking object 402 via a Uu link between the network entity and tracking object 402.

At operation 416, tracking object 402 may determine intrinsic and/or extrinsic parameters of tracking object 402 based on the locations of the keypoints, the positions of the keypoints in the image captured by the camera of tracking object 402, and the correlation between the keypoints and the locations. For example, tracking object 402 may solve the PnP problem based on the locations of the keypoints and the positions of the keypoints in the image captured by the camera of tracking object 402. In cases in which target object 404 provides locations in the coordinate system of target object 404, tracking object 402 may determine its location relative to target object 404 (e.g., tracking object 402 may determine its relative position). In cases in which target object 404 provides the locations in the reference coordinate system, tracking object 402 may determine its location in the reference coordinate system.

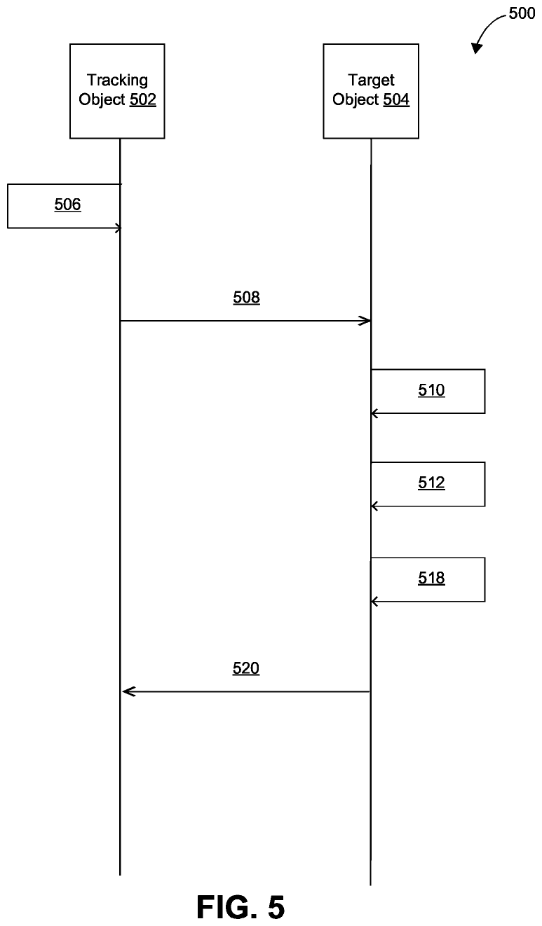

FIG. 5 is a diagram illustrating exemplary process 500 including signaling between tracking object 502 and target object 504 for parameter determination according to various aspects of the present disclosure. Each of the tracking object 502 and target object 504 may be, for example, a wireless communication device. For example, tracking object 502 and/or target object 504 may be a vehicle (e.g., an ego vehicle), a UE, a V2X device, a RSU (e.g., a traffic camera), or a sidelink device. The tracking object 502 and target object 504 may be in the vicinity of one another. In some examples, the tracking object 502 and target object 504 may have established a sidelink therebetween (e.g., via discovery signals). Further, in some examples, tracking object 502 and target object 504 may have agreed to share features and/or location information.

At operation 506, tracking object 502 may determine a plurality of keypoints in an image captured using a camera of tracking object 502. For example, tracking object 502 may capture an image within a field of view of an on-board camera of tracking vehicle and identify a plurality of keypoints in the image using FAST, ORB, BRIEF, SIFT, Harris corner points or another keypoint detection algorithm. Further at operation 506, tracking object 502 may generate a plurality of descriptors based on the image (e.g., using ORB, SURF, BRIEF, or another feature-descriptor algorithm). The plurality of descriptors may include a respective descriptor of each keypoint of the plurality of keypoints.

At operation 508, tracking object 502 may transmit information associated with the plurality of descriptors to target object 504. For example, tracking object 502 may transmit the descriptors, encoded for transmission, to target object 504. Further, tracking object 502 may transmit information associated with the image captured by the camera of tracking object 502. For example, tracking object 502 may transmit information regarding positions of the keypoints in the image. In some cases, tracking object 502 may transmit the image. In some examples, the information may be transmitted via one or more of a unicast sidelink message, a multicast (or groupcast) sidelink message, or a broadcast sidelink message. In other examples, the information may be transmitted via a network entity (e.g., a base station or gNB in an aggregated base station architecture, or a central unit (CU), a distributed unit (DU), a radio unit (RU), a Near-Real Time (Near-RT) RAN Intelligent Controller (RIC), or a Non-Real Time (Non-RT) RIC in a disaggregated base station architecture) in wireless communication with the tracking object 502 and target object 504. For example, the information may be transmitted to the network entity via a Uu link between tracking object 502 and the network entity and the network entity may transmit the information to target object 504 via a Uu link between the network entity and target object 504.

At operation 510, target object 504 may identify at least a subset of the keypoints (determined by tracking object 502 at operation 506) in images captured by target object 504 based on the plurality of descriptors transmitted at operation 508. For example, at, or prior to operation 510, target object 504 may obtain images captured by a camera of target object 504 and camera locations indicative of a location from which each of the images was captured. Based on the descriptors, target object 504 may seek to identify the keypoints (determined by tracking object 502 at operation 506) in the images captured by target object 504, e.g., using a feature-matching technique. The keypoints that are identified in the images captured by target object 504 may be the subset of keypoints.

In some cases, at part of operation 510, target object 504 may select keypoints from among the keypoints provided by tracking object 502. For example, target object 504 may determine which keypoints provided by tracking object 502 are repeatable and consistent and may select such keypoints. In such cases, the subset of keypoints may include the selected keypoints and may exclude keypoints that are not selected. Such selection may precede or follow the identification of the keypoints in the images captured by target object 504. In some cases, though not illustrated in FIG. 5, tracking object 502 may transmit sharing parameters to target object 504. The sharing parameters may include instructions indicative of a threshold for repeatability and/or consistency for target object 504 to use when selecting keypoints.

At operation 512, target object 504 may determine a location of each keypoint of the subset of keypoints in a world coordinate system based on the images captured by the camera of target object 504 and the plurality of camera locations. For example, target object 504 may triangulate a respective location for each of the keypoints based on the images captured by the camera of target object 504 and based on the camera locations from which the images were captured. In some cases, target object 504 may determine the locations in a coordinate system of target object 504. In other cases, target object 504 may determine the locations in a reference coordinate system (e.g., a world coordinate system).

At operation 518, target object 504 may determine intrinsic and/or extrinsic parameters of tracking object 502 based on the locations of the keypoints, the positions of the keypoints in the image captured by the camera of tracking object 502 (e.g., as transmitted at operation 508), and the correlation between the keypoints and the locations. For example, target object 504 may solve the PnP problem based on the locations of the keypoints and the positions of the keypoints in the image captured by the camera of tracking object 502. In cases in which target object 504 determined locations in the coordinate system of target object 504, target object 504 may determine the location of tracking object 502 relative to target object 504 (e.g., target object 504 may determine a relative position of tracking object 502). In cases in which target object 504 determined the locations in the reference coordinate system, target object 504 may determine the location of tracking object 502 in the reference coordinate system.

At operation 520, target object 504 may transmit information associated with the locations of tracking object 502 to tracking object 502. For example, target object 504 may transmit the locations of tracking object 502, encoded for transmission, to tracking object 502. In some examples, the information may be transmitted via one or more of a unicast sidelink message, a multicast (or groupcast) sidelink message, or a broadcast sidelink message. In other examples, the information may be transmitted via a network entity (e.g., a base station or gNB in an aggregated base station architecture, or a central unit (CU), a distributed unit (DU), a radio unit (RU), a Near-Real Time (Near-RT) RAN Intelligent Controller (RIC), or a Non-Real Time (Non-RT) RIC in a disaggregated base station architecture) in wireless communication with the tracking object 502 and target object 504. For example, the information may be transmitted to the network entity via a Uu link between target object 504 and the network entity and the network entity may transmit the information to tracking object 502 via a Uu link between the network entity and tracking object 502.

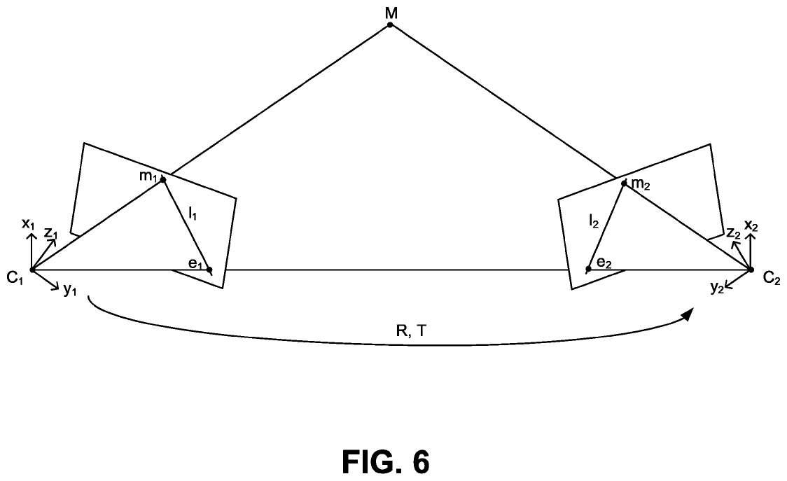

FIG. 6 is a diagram illustrating an example of relative pose determination using keypoints from images captured at different cameras C1 and C2 according to various aspects of the present disclosure. In the example shown in FIG. 6, each of the cameras C1 and C2 may be positioned on a different wireless communication device, such as a vehicle or RSU. A real point M in three-dimensional space (x, y, z) may be projected onto the respective image planes I1 and I2 of each of the vehicle cameras C1 and C2 to produce features (keypoints) m1 and m2. By correlating or associating (e.g., matching) multiple sets of features (e.g., corresponding to multiple real points), the epipolar constraint (e.g., line l1 between m1 and e1 and line l2 between m2 and e2) on the relative vehicle pose may be extracted. As a result, based on the keypoints of multiple real points and the epipolar constraint, a first wireless communication device associated with camera C1 may determine the relative pose (Rotation (R), Translation (T)) of the first wireless communication device with respect to a second wireless communication device associated with camera C2. If the location of one camera C1 or camera C2 (in a global coordinate system) is known, the relative pose may be used to determine the location of the other of the cameras (in the global coordinate system).

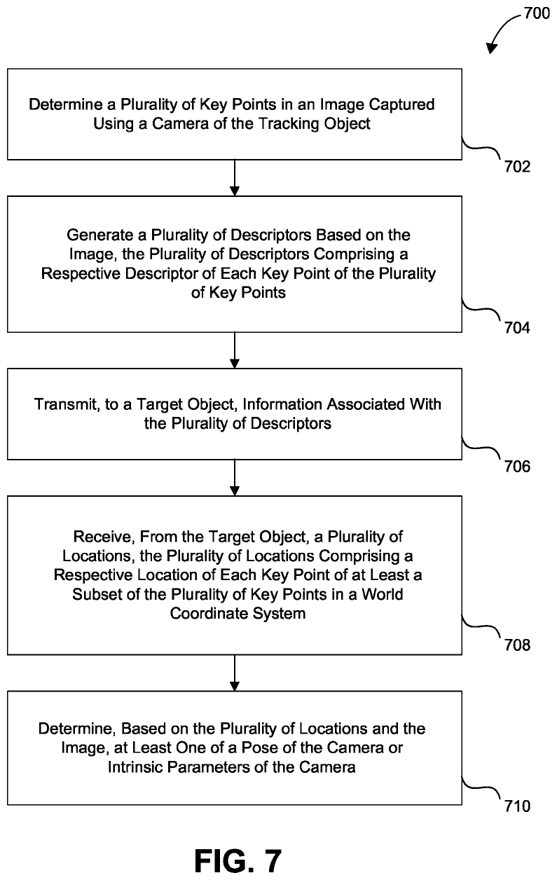

FIG. 7 is a flow diagram illustrating an example process 700 for determining parameters of a tracking object, in accordance with aspects of the present disclosure. One or more operations of process 700 may be performed by a computing device (or apparatus) or a component (e.g., a chipset, codec, etc.) of the computing device. The computing device may be a vehicle or component or system of a vehicle, a mobile device (e.g., a mobile phone), a network-connected wearable such as a watch, an extended reality (XR) device such as a virtual reality (VR) device or augmented reality (AR) device, or other type of computing device. The one or more operations of process 700 may be implemented as software components that are executed and run on one or more processors.

At block 702, a computing device (or one or more components thereof) may determine a plurality of keypoints in an image captured using a camera of the tracking object. For example, tracking vehicle 302 of FIG. 3 (or a computing device thereof) may determine a plurality of keypoints in an image (e.g., keypoint 202 in image 200 of FIG. 2) captured by a camera of tracking vehicle 302. As another example, tracking object 402 of FIG. 4 (or a computing device thereof) may determine a plurality of keypoints in an image (e.g., keypoint 202 in image 200 of FIG. 2) captured by a camera of tracking object 402 (e.g., at operation 406).

In some aspects, the plurality of keypoints may be determined based on a respective distinctiveness of each keypoint of the plurality of keypoints in the image. For example, tracking vehicle 302 (or tracking object 402) may determine the keypoints based on the distinctiveness of the keypoints. In some aspects, the plurality of keypoints may be determined based on a respective consistency of each keypoint of the plurality of keypoints in a plurality of images captured by the camera of the tracking object. For example, tracking vehicle 302 (or tracking object 402) may determine the keypoints based on the consistency of each keypoints in a plurality of images captured by the camera of the tracking object 302 (or tracking object 402).

At block 704, the computing device (or one or more components thereof) may generate a plurality of descriptors based on the image, the plurality of descriptors comprising a respective descriptor of each keypoint of the plurality of keypoints. For example, tracking vehicle 302 (or a computing device thereof) may generate descriptors for each of the keypoints determined at block 702. As another example, tracking object 402 (or a computing device thereof) may generate descriptors for each of the keypoints determined at block 702 (e.g., at operation 406).

At block 706, the computing device (or one or more components thereof) may transmit, to a target object, information associated with the plurality of descriptors. For example, tracking vehicle 302 (or a computing device thereof) may transmit information associated with the descriptors to target vehicle 304 of FIG. 3. As another example, tracking object 402 (or a computing device thereof) may transmit information associated with the descriptors to target object 404 of FIG. 4 (e.g., at operation 408).

In some aspects, the information may include a request for the plurality of locations. For example, tracking vehicle 302 may transmit, to target vehicle 304, a request to determine locations of the keypoints determined at block 702. For example, tracking vehicle 402 may transmit, to target vehicle 404, a request to determine locations of the keypoints determined at block 702. In some aspects, the computing device (or one or more components thereof) may transmit, to the target object, instructions regarding consistencies for identifying the subset of the plurality of keypoints. For example, tracking vehicle 302 may transmit, to target vehicle 304, instructions regarding the consistency of keypoints. Target vehicle 304 may determine locations for keypoints that satisfy a consistency threshold of the instructions. As another example, tracking vehicle 402 may transmit, to target vehicle 404, instructions regarding the consistency of keypoints. Target vehicle 404 may determine locations for keypoints that satisfy a consistency threshold of the instructions.

At block 708, the computing device (or one or more components thereof) may receive, from the target object, a plurality of locations, the plurality of locations comprising a respective location of each keypoint of at least a subset of the plurality of keypoints in a world coordinate system. For example, tracking vehicle 302 may receive, from target vehicle 304, locations of at least a subset of the keypoints determined at block 702. As another example, tracking object 402 may receive, from target object 404, locations of at least a subset of the keypoints determined at block 702 (e.g., at operation 414).

In some aspects, the computing device (or one or more components thereof) may receive, from the target object, an association between each location of the plurality of locations and a respective keypoint of at least the subset of the plurality of keypoints. For example, tracking vehicle 302 (or tracking object 402) may receive, from target vehicle 304 (or target object 404), an association between the keypoints determined at block 702 and the locations received at block 708.

At block 710, the computing device (or one or more components thereof) may determine, based on the plurality of locations and the image, at least one of a pose of the camera or intrinsic parameters of the camera. For example, tracking vehicle 302 may determine a pose of the camera and/or intrinsic parameters of the camera based on the locations received at block 708. As another example, tracking vehicle 402 may determine a pose of the camera and/or intrinsic parameters of the camera based on the locations received at block 708 (e.g., at operation 416).

In some aspects, at least one of the pose of the camera or the intrinsic parameters of the camera may be determined based on the respective location of each keypoint of the plurality of keypoints and a respective position of each keypoint of the plurality of keypoints in the image. For example, tracking object 302 (or tracking object 402) may solve the PnP problem based on the locations of the keypoints (received at block 708) and the positions of the keypoints in the image captured by the camera of tracking object 302 (or tracking object 402).

In some aspects, the pose of the camera may be, or may include, a location and an orientation of the camera in the world coordinate system. For example, tracking vehicle 302 (or tracking object 402) may determine, at block 710, a location and an orientation of tracking vehicle 302 (or tracking object 402). In some aspects, the intrinsic parameters of the camera may be, or may include, at least one of a focal length of the camera, an image size related to the camera, or distortion parameters of the camera. For example, tracking vehicle 302 (or tracking object 402) may determine, at block 710, a focal length of the camera, an image size related to the camera, and/or distortion parameters of the camera.

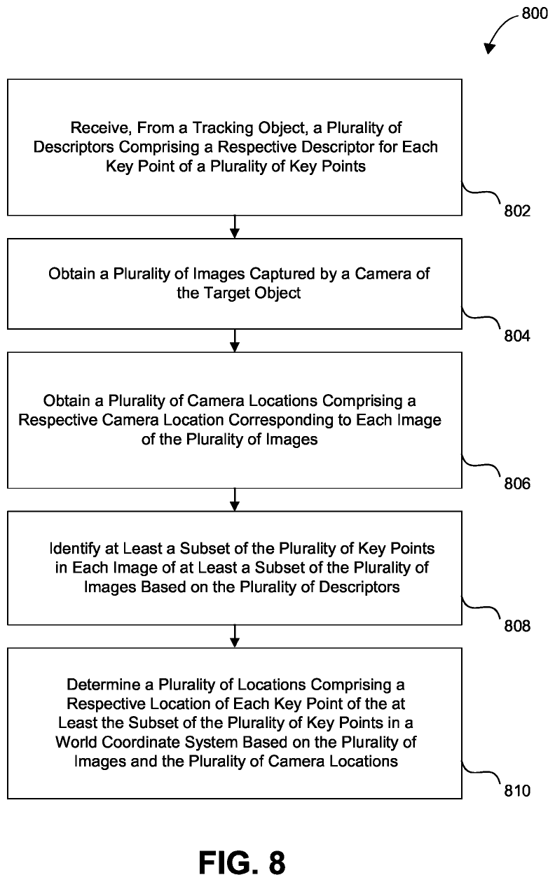

FIG. 8 is a flow diagram illustrating an example process 800 for determining parameters of a tracking object, in accordance with aspects of the present disclosure. One or more operations of process 800 may be performed by a computing device (or apparatus) or a component (e.g., a chipset, codec, etc.) of the computing device. The computing device may be a vehicle or component or system of a vehicle, a mobile device (e.g., a mobile phone), a network-connected wearable such as a watch, an extended reality (XR) device such as a virtual reality (VR) device or augmented reality (AR) device, a desktop computing device, a tablet computing device, a server computer, a robotic device,, and/or any other computing device with the resource capabilities to perform the process 800. The one or more operations of process 800 may be implemented as software components that are executed and run on one or more processors.

At block 802, a computing device (or one or more components thereof) may receive, from a tracking object, a plurality of descriptors comprising a respective descriptor for each keypoint of a plurality of keypoints. For example, target vehicle 304 of FIG. 3 may receive, from tracking vehicle 302 of FIG. 3, descriptors describing keypoints (e.g., keypoint 202 in image 200 of FIG. 2). Tracking vehicle 302 may identify the keypoints in an image captured by tracking vehicle 302. As another example, target vehicle 504 of FIG. 5 may receive, from tracking vehicle 502 of FIG. 5 (e.g., at operation 508), descriptors describing keypoints (e.g., keypoint 202 in image 200 of FIG. 2). Tracking vehicle 502 may identify the keypoints in an image captured by tracking vehicle 502 (e.g., at operation 506).

At block 804, the computing device (or one or more components thereof) may obtain a plurality of images captured by a camera of the target object. For example, target vehicle 304 may obtain images captured by a camera of target vehicle 304. As another example, target vehicle 504, may obtain images captured by a camera of target vehicle 504.

At block 806, the computing device (or one or more components thereof) may obtain a plurality of camera locations comprising a respective camera location corresponding to each image of the plurality of images. For example, target vehicle 304 may obtain locations corresponding to the images obtained at block 804. As another example, target vehicle 504 may obtain locations corresponding to the images obtained at block 804.

At block 808, the computing device (or one or more components thereof) may identify at least a subset of the plurality of keypoints in each image of at least a subset of the plurality of images based on the plurality of descriptors. For example, target vehicle 304 may identify keypoints, as described by the descriptors received at block 802, in the images obtained at block 804. As another example, target vehicle 504 may identify keypoints, as described by the descriptors received at block 802, in the images obtained at block 804 (e.g., at operation 510).

At block 810, the computing device (or one or more components thereof) may determine a plurality of locations comprising a respective location of each keypoint of at least the subset of the plurality of keypoints in a world coordinate system based on the plurality of images and the plurality of camera locations. For example, target vehicle 304 may determine locations in a world coordinate system for at least a subset of the keypoints described by the descriptors received at block 802 and identified at block 808. As another example, target vehicle 504 may determine locations in a world coordinate system for at least a subset of the keypoints described by the descriptors received at block 802 and identified at block 808 (e.g., at operation 512).

In some aspects, the computing device (or one or more components thereof) may transmit, to the tracking object, information associated with the plurality of locations. For example, target vehicle 304 (or target object 504) may transmit indications of the locations of the keypoints received at block 802 to tracking vehicle 302 (or tracking object 502, for example, at operation 520). In some aspects, the information is transmitted for the tracking object to determine at least one of a pose of the tracking object or intrinsic parameters of a camera of the tracking object. For example, based on the information transmitted by target vehicle 304 (or target object 504) at block 810, tracking vehicle 302 (or tracking object 502) may determine a pose of tracking vehicle 302 (or tracking object 502) and/or intrinsic parameters of a camera of tracking vehicle 302 (or tracking object 502).

In some aspects, the computing device (or one or more components thereof) may receive, from the tracking object, a respective position of each keypoint of the plurality of keypoints in an image captured using a camera of the tracking object; determine at least one of a pose of the tracking object or intrinsic parameters of the camera of the tracking object based on the plurality of locations and each respective position of each keypoint of the plurality of keypoints in the image; and transmit, to the tracking object, information associated with at least one of the pose of the tracking object or the intrinsic parameters of the camera of the tracking object. For example, target vehicle 304 (or target object 504) may receive, from tracking vehicle 302 (or tracking object 502), positions of the keypoints described by the descriptors received at block 802 in an image captured by tracking vehicle 302 (or tracking object 502). Based on the positions, target object 304 (or target object 504) may determine a pose of tracking vehicle 302 (or tracking object 502) and/or intrinsic parameters of a camera of tracking vehicle 302 (or tracking object 502). Target vehicle 304 (or target object 504) may transmit the pose of tracking vehicle 302 (or tracking object 502) and/or the intrinsic parameters to tracking vehicle 302 (or tracking object 502). In some aspects, the respective position of each keypoint of the plurality of keypoints in the image may be, or may include, a two-dimensional position within the image. In some aspects, the plurality of locations may be, or may include, three-dimensional locations relative to the world coordinate system. For example, the positions of the keypoints in the image may be two-dimensional positions within the image. The location may be a three-dimensional location of tracking vehicle 302 (or tracking object 502) in a world coordinate system.

In some aspects, the computing device (or one or more components thereof) may determine the subset of the plurality of keypoints based on a respective distinctiveness of each keypoint of at least the subset of the plurality of keypoints in each image of at least the subset of the plurality of images. For example, target vehicle 304 (or target object 504) may determine the subset of keypoints for which to determine a location based on the distinctiveness of the subset of keypoints. For example, target vehicle 304 (or target object 504) may determine the locations of highly distinctive keypoints. In some aspects, the computing device (or one or more components thereof) may determine the subset of the plurality of keypoints based on a respective consistency of each keypoint of at least the subset of the plurality of keypoints in each image of at least the subset of the plurality of images. For example, target vehicle 304 (or target object 504) may determine the subset of keypoints for which to determine a location based on the consistency of the subset of keypoints in multiple images. For example, target vehicle 304 (or target object 504) may determine the locations of keypoints that are consistent across multiple images. In some aspects, the computing device (or one or more components thereof) may receive, from the tracking object, instructions regarding consistencies for identifying the subset of the plurality of keypoints. For example, target vehicle 304 (or target object 504) may receive, from tracking vehicle 302 (or tracking object 502) instructions regarding the selection of the keypoints for which to determine a location. The instructions may include a consistency threshold.

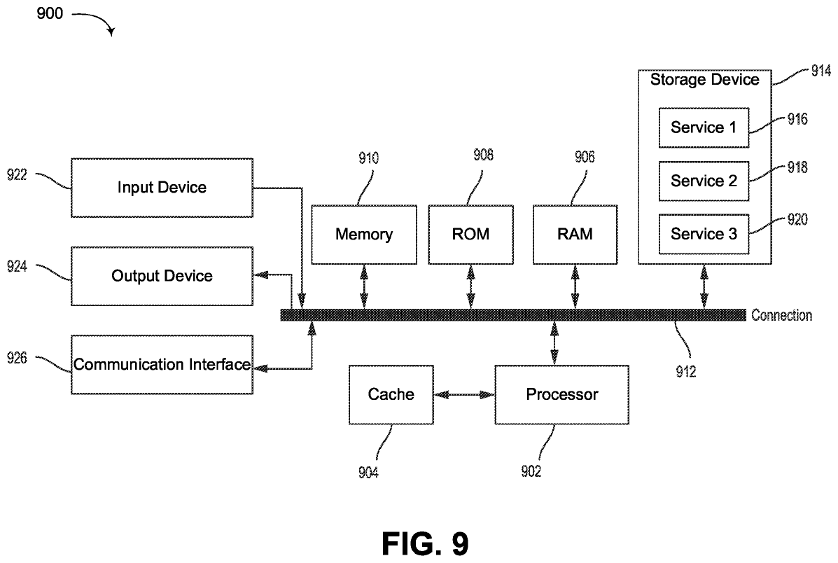

In some examples, as noted previously, the methods described herein (e.g., process 700 of FIG. 7, process 800 of FIG. 8, and/or other methods described herein) can be performed, in whole or in part, by a computing device or apparatus. In one example, one or more of the methods can be performed by tracking vehicle 302 of FIG. 3, target vehicle 304 of FIG. 3, tracking object 402 of FIG. 4, target object 404 of FIG. 4, tracking object 502 of FIG. 5, and/or target object 504 of FIG. 5, by a computing device thereof, or by another system or device. In another example, one or more of the methods (e.g., process 700 of FIG. 7, process 800 of FIG. 8, and/or other methods described herein) can be performed, in whole or in part, by the computing-device architecture 900 shown in FIG. 9. For instance, a computing device with the computing-device architecture 900 shown in FIG. 9 can include, or be included in, the components of tracking vehicle 302, target vehicle 304, tracking object 402, target object 404, tracking object 502, and/or target object 504 and can implement the operations of process 700, process 800, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 800 and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 700, process 800, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 9 illustrates an example computing-device architecture 900 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 900 may include, implement, or be included in any or all of tracking vehicle 302 of FIG. 3, target vehicle 304 of FIG. 3, tracking object 402 of FIG. 4, target object 404 of FIG. 4, tracking object 502 of FIG. 5, and/or target object 504 of FIG. 5.

The components of computing-device architecture 900 are shown in electrical communication with each other using connection 912, such as a bus. The example computing-device architecture 900 includes a processing unit (CPU or processor) 902 and computing device connection 912 that couples various computing device components including computing device memory 910, such as read only memory (ROM) 908 and random-access memory (RAM) 906, to processor 902.

Computing-device architecture 900 can include a cache of high-speed memory connected directly with, in close proximity to, or integrated as part of processor 902. Computing-device architecture 900 can copy data from memory 910 and/or the storage device 914 to cache 904 for quick access by processor 902. In this way, the cache can provide a performance boost that avoids processor 902 delays while waiting for data. These and other modules can control or be configured to control processor 902 to perform various actions. Other computing device memory 910 may be available for use as well. Memory 910 can include multiple different types of memory with different performance characteristics. Processor 902 can include any general-purpose processor and a hardware or software service, such as service 1 916, service 2 918, and service 3 920 stored in storage device 914, configured to control processor 902 as well as a special-purpose processor where software instructions are incorporated into the processor design. Processor 902 may be a self-contained system, containing multiple cores or processors, a bus, memory controller, cache, etc. A multi-core processor may be symmetric or asymmetric.

To enable user interaction with the computing-device architecture 900, input device 922 can represent any number of input mechanisms, such as a microphone for speech, a touch-sensitive screen for gesture or graphical input, keyboard, mouse, motion input, speech and so forth. Output device 924 can also be one or more of a number of output mechanisms known to those of skill in the art, such as a display, projector, television, speaker device, etc. In some instances, multimodal computing devices can enable a user to provide multiple types of input to communicate with computing-device architecture 900. Communication interface 926 can generally govern and manage the user input and computing device output. There is no restriction on operating on any particular hardware arrangement and therefore the basic features here may easily be substituted for improved hardware or firmware arrangements as they are developed.

Storage device 914 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 906, read only memory (ROM) 908, and hybrids thereof. Storage device 914 can include services 916, 918, and 920 for controlling processor 902. Other hardware or software modules are contemplated. Storage device 914 can be connected to the computing device connection 912. In one aspect, a hardware module that performs a particular function can include the software component stored in a computer-readable medium in connection with the necessary hardware components, such as processor 902, connection 912, output device 924, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for determining parameters of a tracking object, the apparatus comprising: at least one memory; and at least one processor coupled to the at least one memory and configured to: determine a plurality of keypoints in an image captured using a camera of the tracking object; generate a plurality of descriptors based on the image, the plurality of descriptors comprising a respective descriptor of each keypoint of the plurality of keypoints; cause at least one transmitter to transmit, to a target object, information associated with the plurality of descriptors; receive, from the target object, a plurality of locations, the plurality of locations comprising a respective location of each keypoint of at least a subset of the plurality of keypoints in a world coordinate system; and determine, based on the plurality of locations and the image, at least one of a pose of the camera or intrinsic parameters of the camera.
Aspect 2. The apparatus of aspect 1, wherein at least one of the pose of the camera or the intrinsic parameters of the camera are determined based on the respective location of each keypoint of the plurality of keypoints and a respective position of each keypoint of the plurality of keypoints in the image.
Aspect 3. The apparatus of any one of aspects 1 or 2, wherein the at least one processor is further configured to receive, from the target object, an association between each location of the plurality of locations and a respective keypoint of at least the subset of the plurality of keypoints.
Aspect 4. The apparatus of any one of aspects 1 to 3, wherein the pose of the camera comprises a location and an orientation of the camera in the world coordinate system.
Aspect 5. The apparatus of any one of aspects 1 to 4, wherein the intrinsic parameters of the camera comprise at least one of a focal length of the camera, an image size related to the camera, or distortion parameters of the camera.
Aspect 6. The apparatus of any one of aspects 1 to 5, wherein the information further comprises a request for the plurality of locations.
Aspect 7. The apparatus of any one of aspects 1 to 6, wherein the plurality of keypoints are determined based on a respective distinctiveness of each keypoint of the plurality of keypoints in the image.
Aspect 8. The apparatus of any one of aspects 1 to 7, wherein the plurality of keypoints are determined based on a respective consistency of each keypoint of the plurality of keypoints in a plurality of images captured by the camera of the tracking object.
Aspect 9. The apparatus of any one of aspects 1 to 8, wherein the at least one processor is further configured to cause the at least one transmitter to transmit, to the target object, instructions regarding consistencies for identifying the subset of the plurality of keypoints.
Aspect 10. The apparatus of any one of aspects 1 to 9, further comprising the at least one transmitter, the at least one transmitter configured to transmit the information associated with the plurality of descriptors.
Aspect 11. An apparatus for determining locations at a target object, the apparatus comprising: at least one memory; and at least one processor coupled to the at least one memory and configured to: receive, from a tracking object, a plurality of descriptors comprising a respective descriptor for each keypoint of a plurality of keypoints; obtain a plurality of images captured by a camera of the target object; obtain a plurality of camera locations comprising a respective camera location corresponding to each image of the plurality of images; identify at least a subset of the plurality of keypoints in each image of at least a subset of the plurality of images based on the plurality of descriptors; and determine a plurality of locations comprising a respective location of each keypoint of at least the subset of the plurality of keypoints in a world coordinate system based on the plurality of images and the plurality of camera locations.
Aspect 12. The apparatus of aspect 11, wherein the at least one processor is further configured to cause at least one transmitter to transmit, to the tracking object, information associated with the plurality of locations.
Aspect 13. The apparatus of any one of aspects 11 or 12, wherein the information is transmitted for the tracking object to determine at least one of a pose of the tracking object or intrinsic parameters of a camera of the tracking object.
Aspect 14. The apparatus of aspect 12, further comprising the at least one transmitter, the at least one transmitter configured to transmit the information associated with the plurality of descriptors.
Aspect 15. The apparatus of any one of aspects 11 to 14, wherein the at least one processor is further configured to: receive, from the tracking object, a respective position of each keypoint of the plurality of keypoints in an image captured using a camera of the tracking object; determine at least one of a pose of the tracking object or intrinsic parameters of the camera of the tracking object based on the plurality of locations and each respective position of each keypoint of the plurality of keypoints in the image; and cause at least one transmitter to transmit, to the tracking object, information associated with at least one of the pose of the tracking object or the intrinsic parameters of the camera of the tracking object.
Aspect 16. The apparatus of aspect 15, wherein the respective position of each keypoint of the plurality of keypoints in the image comprises a two-dimensional position within the image and wherein the plurality of locations comprise three-dimensional locations relative to the world coordinate system.
Aspect 17. The apparatus of any one of aspects 15 or 16, further comprising the at least one transmitter, the at least one transmitter configured to transmit the information associated with at least one of the pose of the tracking object or the intrinsic parameters of the camera of the tracking object.
Aspect 18. The apparatus of any one of aspects 11 to 17, wherein the at least one processor is further configured to determine the subset of the plurality of keypoints based on a respective distinctiveness of each keypoint of at least the subset of the plurality of keypoints in each image of at least the subset of the plurality of images.
Aspect 19. The apparatus of any one of aspects 11 to 18, wherein the at least one processor is further configured to determine the subset of the plurality of keypoints based on a respective consistency of each keypoint of at least the subset of the plurality of keypoints in each image of at least the subset of the plurality of images.
Aspect 20. The apparatus of any one of aspects 11 to 19, wherein the at least one processor is further configured to receive, from the tracking object, instructions regarding consistencies for identifying the subset of the plurality of keypoints.
Aspect 21. The apparatus of any one of aspects 11 to 20, wherein the plurality of locations comprise three-dimensional locations relative to the world coordinate system.
Aspect 22. A method for determining parameters of a tracking object, the method comprising: determining a plurality of keypoints in an image captured using a camera of the tracking object; generating a plurality of descriptors based on the image, the plurality of descriptors comprising a respective descriptor of each keypoint of the plurality of keypoints; transmitting, to a target object, information associated with the plurality of descriptors; receiving, from the target object, a plurality of locations, the plurality of locations comprising a respective location of each keypoint of at least a subset of the plurality of keypoints in a world coordinate system; and determining, based on the plurality of locations and the image, at least one of a pose of the camera or intrinsic parameters of the camera.
Aspect 23. The method of aspect 22, wherein at least one of the pose of the camera or the intrinsic parameters of the camera are determined based on the respective location of each keypoint of the plurality of keypoints and a respective position of each keypoint of the plurality of keypoints in the image.
Aspect 24. The method of any one of aspects 22 or 23, further comprising receiving, from the target object, an association between each location of the plurality of locations and a respective keypoint of at least the subset of the plurality of keypoints.
Aspect 25. The method of any one of aspects 22 to 24, wherein the pose of the camera comprises a location and an orientation of the camera in the world coordinate system.
Aspect 26. The method of any one of aspects 22 to 25, wherein the intrinsic parameters of the camera comprise at least one of a focal length of the camera, an image size related to the camera, or distortion parameters of the camera.
Aspect 27. The method of any one of aspects 22 to 26, wherein the information further comprises a request for the plurality of locations.
Aspect 28. The method of any one of aspects 22 to 27, wherein the plurality of keypoints are determined based on a respective distinctiveness of each keypoint of the plurality of keypoints in the image.
Aspect 29. The method of any one of aspects 22 to 28, wherein the plurality of keypoints are determined based on a respective consistency of each keypoint of the plurality of keypoints in a plurality of images captured by the camera of the tracking object.
Aspect 30. The method of any one of aspects 22 to 29, further comprising transmitting, to the target object, instructions regarding consistencies for identifying the subset of the plurality of keypoints.
Aspect 31. A method for determining locations at a target object, the method comprising: receiving, from a tracking object, a plurality of descriptors comprising a respective descriptor for each keypoint of a plurality of keypoints; obtaining a plurality of images captured by a camera of the target object; obtaining a plurality of camera locations comprising a respective camera location corresponding to each image of the plurality of images; identifying at least a subset of the plurality of keypoints in each image of at least a subset of the plurality of images based on the plurality of descriptors; and determining a plurality of locations comprising a respective location of each keypoint of at least the subset of the plurality of keypoints in a world coordinate system based on the plurality of images and the plurality of camera locations.
Aspect 32. The method of aspect 31, further comprising transmitting, to the tracking object, information associated with the plurality of locations.
Aspect 33. The method of any one of aspects 31 or 32, wherein the information is transmitted for the tracking object to determine at least one of a pose of the tracking object or intrinsic parameters of a camera of the tracking object.
Aspect 34. The method of any one of aspects 31 to 33, further comprising: receiving, from the tracking object, a respective position of each keypoint of the plurality of keypoints in an image captured using a camera of the tracking object; determining at least one of a pose of the tracking object or intrinsic parameters of the camera of the tracking object based on the plurality of locations and each respective position of each keypoint of the plurality of keypoints in the image; and transmitting, to the tracking object, information associated with at least one of the pose of the tracking object or the intrinsic parameters of the camera of the tracking object.
Aspect 35. The method of any one of aspects 31 to 34, wherein the respective position of each keypoint of the plurality of keypoints in the image comprises a two-dimensional position within the image and wherein the plurality of locations comprise three-dimensional locations relative to the world coordinate system.
Aspect 36. The method of any one of aspects 31 to 35, further comprising determining at least the subset of the plurality of keypoints based on a respective distinctiveness of each keypoint of at least the subset of the plurality of keypoints in each image of at least the subset of the plurality of images.
Aspect 37. The method of any one of aspects 31 to 36, further comprising determining at least the subset of the plurality of keypoints based on a respective consistency of each keypoint of at least the subset of the plurality of keypoints in each image of at least the subset of the plurality of images.
Aspect 38. The method of any one of aspects 31 to 37, further comprising receiving, from the tracking object, instructions regarding consistencies for identifying the subset of the plurality of keypoints.
Aspect 39. The method of any one of aspects 31 to 38, wherein the plurality of locations comprise three-dimensional locations relative to the world coordinate system.
Aspect 40. A method for determining parameters of a tracking object, comprising: determining a plurality of keypoints in an image captured using a camera of the tracking object; generating a plurality of descriptors based on the image, the plurality of descriptors comprising a respective descriptor of each keypoint of the plurality of keypoints; transmitting, to a target object, information associated with the plurality of descriptors; receiving, from a tracking object, the information associated with the plurality of descriptors; obtaining a plurality of images captured by a camera of the target object; obtaining a plurality of camera locations comprising a respective camera location corresponding to each image of the plurality of images; identifying at least a subset of the plurality of keypoints in each image of at least a subset of the plurality of images based on the plurality of descriptors; determining a plurality of locations comprising a respective location of each keypoint of the at least the subset of the plurality of keypoints in a world coordinate system based on the plurality of images and the plurality of camera locations; receiving, from the target object, the plurality of locations; and determining, based on the plurality of locations and the image, at least one of a pose of the camera or intrinsic parameters of the camera.
Aspect 41. A non-transitory computer-readable storage medium having stored thereon instructions that, when executed by at least one processor, cause the at least one processor to perform operations according to any of aspects 22 to 40.
Aspect 42. An apparatus for providing virtual content for display, the apparatus comprising one or more means for perform operations according to any of aspects 22 to 40.

1. An apparatus for determining parameters of a tracking object, the apparatus comprising:
at least one memory; and
at least one processor coupled to the at least one memory and configured to:
determine a plurality of keypoints in an image captured using a camera of the tracking object;
generate a plurality of descriptors based on the image, the plurality of descriptors comprising a respective descriptor of each keypoint of the plurality of keypoints;
cause at least one transmitter to transmit, to a target object, information associated with the plurality of descriptors;
receive, from the target object, a plurality of locations, the plurality of locations comprising a respective location of each keypoint of at least a subset of the plurality of keypoints in a world coordinate system; and
determine, based on the plurality of locations and the image, at least one of a pose of the camera or intrinsic parameters of the camera.

2. The apparatus of claim 1, wherein at least one of the pose of the camera or the intrinsic parameters of the camera are determined based on the respective location of each keypoint of the plurality of keypoints and a respective position of each keypoint of the plurality of keypoints in the image.

3. The apparatus of claim 1, wherein the at least one processor is further configured to receive, from the target object, an association between each location of the plurality of locations and a respective keypoint of at least the subset of the plurality of keypoints.

4. The apparatus of claim 1, wherein the pose of the camera comprises a location and an orientation of the camera in the world coordinate system.

5. The apparatus of claim 1, wherein the intrinsic parameters of the camera comprise at least one of a focal length of the camera, an image size related to the camera, or distortion parameters of the camera.

6. (canceled)

7. The apparatus of claim 1, wherein the plurality of keypoints are determined based on a respective distinctiveness of each keypoint of the plurality of keypoints in the image.

8. The apparatus of claim 1, wherein the plurality of keypoints are determined based on a respective consistency of each keypoint of the plurality of keypoints in a plurality of images captured by the camera of the tracking object.

9. The apparatus of claim 1, wherein the at least one processor is further configured to cause the at least one transmitter to transmit, to the target object, instructions regarding consistencies for identifying the subset of the plurality of keypoints.

10. The apparatus of claim 1, further comprising the at least one transmitter, the at least one transmitter configured to transmit the information associated with the plurality of descriptors.

11. An apparatus for determining locations at a target object, the apparatus comprising:
at least one memory; and
at least one processor coupled to the at least one memory and configured to:
receive, from a tracking object, a plurality of descriptors comprising a respective descriptor for each keypoint of a plurality of keypoints;
obtain a plurality of images captured by a camera of the target object;
obtain a plurality of camera locations comprising a respective camera location corresponding to each image of the plurality of images;
identify at least a subset of the plurality of keypoints in each image of at least a subset of the plurality of images based on the plurality of descriptors; and
determine a plurality of locations comprising a respective location of each keypoint of at least the subset of the plurality of keypoints in a world coordinate system based on the plurality of images and the plurality of camera locations.

12. (canceled)

13. The apparatus of claim 12, wherein the information is transmitted for the tracking object to determine at least one of a pose of the tracking object or intrinsic parameters of a camera of the tracking object.

14. The apparatus of claim 12, further comprising the at least one transmitter, the at least one transmitter configured to transmit the information associated with the plurality of descriptors.

15. The apparatus of claim 11, wherein the at least one processor is further configured to:
receive, from the tracking object, a respective position of each keypoint of the plurality of keypoints in an image captured using a camera of the tracking object;
determine at least one of a pose of the tracking object or intrinsic parameters of the camera of the tracking object based on the plurality of locations and each respective position of each keypoint of the plurality of keypoints in the image; and
cause at least one transmitter to transmit, to the tracking object, information associated with at least one of the pose of the tracking object or the intrinsic parameters of the camera of the tracking object.

16. The apparatus of claim 15, wherein the respective position of each keypoint of the plurality of keypoints in the image comprises a two-dimensional position within the image and wherein the plurality of locations comprise three-dimensional locations relative to the world coordinate system.

17. The apparatus of claim 15, further comprising the at least one transmitter, the at least one transmitter configured to transmit the information associated with at least one of the pose of the tracking object or the intrinsic parameters of the camera of the tracking object.

18. The apparatus of claim 11, wherein the at least one processor is further configured to determine the subset of the plurality of keypoints based on a respective distinctiveness of each keypoint of at least the subset of the plurality of keypoints in each image of at least the subset of the plurality of images.

19. The apparatus of claim 11, wherein the at least one processor is further configured to determine the subset of the plurality of keypoints based on a respective consistency of each keypoint of at least the subset of the plurality of keypoints in each image of at least the subset of the plurality of images.

20. (canceled)

21. (canceled)

22. A method for determining parameters of a tracking object, the method comprising:
determining a plurality of keypoints in an image captured using a camera of the tracking object;
generating a plurality of descriptors based on the image, the plurality of descriptors comprising a respective descriptor of each keypoint of the plurality of keypoints;
transmitting, to a target object, information associated with the plurality of descriptors;
receiving, from the target object, a plurality of locations, the plurality of locations comprising a respective location of each keypoint of at least a subset of the plurality of keypoints in a world coordinate system; and
determining, based on the plurality of locations and the image, at least one of a pose of the camera or intrinsic parameters of the camera.

23. The method of claim 22, wherein at least one of the pose of the camera or the intrinsic parameters of the camera are determined based on the respective location of each keypoint of the plurality of keypoints and a respective position of each keypoint of the plurality of keypoints in the image.

24. The method of claim 22, further comprising receiving, from the target object, an association between each location of the plurality of locations and a respective keypoint of at least the subset of the plurality of keypoints.

25. (canceled)

26. (canceled)

27. (canceled)

28. (canceled)

29. (canceled)

30. (canceled)
